(19) United States
(12) Patent Application Publication
(10) Pub. No.: US 2004/0239643 A1
(43) Pub. Date: Dec. 2, 2004

(54) Graphical user interface

(76) Inventor: Andrew Bangham, Cambridge (GB)

Correspondence Address: Boyle Fredrickson Newholm, Stein & Gratz, Suite 1030, 250 East Wisconsin Avenue, Milwaukee, WI, 53202, US

(21) Appl. No.: 10/491,863

(22) PCT Filed: Oct. 8, 2002
(86) PCT No.: PCT/GB02/04577

(30) Foreign Application Priority Data
Oct. 8, 2001 (GB) 0124155.3

(51) Int. Cl. G09G 5/00; G09G 3/36; G09G 3/28

(52) U.S. Cl. 345/173; 345/182; 345/104

(57) ABSTRACT

A graphical user interface for enbaling a user to input data to a software operating device. The interface comprises a display, and means for receiving selected position data representing a selected position on the display from a user. Means converts the selected position data to function identification information for software operating device. The display is arranged to display a selection panel representing a plurality of functions, the panel having an array of regions aligned in a first direction, each region representing a function, and the positional data is converted to function identification information by considering the position within the panel in the first direction and also in a directional orthogonal thereto.

A significant problem facing program designers is how to make controls for a program easily accessible to users through a Graphical User Interface (GUI). Most software applications interact with the user through an application window. For example, a spreadsheet application provides a means to enter and edit numbers in a document that behaves as a two dimensional table. A word-processing user edits a document that mimics the look of a sheet of paper. An image software user works on a document that looks like a picture, photograph or drawing. The applications provide a number of means for interacting with the document. These include menus, dialogue boxes, slider and pickers. Pull down menus are illustrated in FIG. 2. In this example, the function to be used when brushing a colour onto a document using an image software package is selected. A pull-down menu takes up very little screen real estate because it collapses to a small box. A disadvantage lies in the number user operations required to select any one function. In this example, two mouse or keyboard operations (clicks) are required. A second disadvantage lies in the discrete nature of the options that may be selected. In this example a maximum of 18 different functions can be selected.

The second problem is commonly addressed by using a slider. A slider allows a single value to be chosen from an approximately continuous range of values. The example shown in FIG. 3 is a means for both the brightness and the contrast of an image in a document to be adjusted. The sliders provide an easy means to vary brightness and contrast separately it is, however, harder to alter both at once. To produce an attractive image by adjusting both requires each to be adjusted in turn and this can take a large number of mouse button clicks.

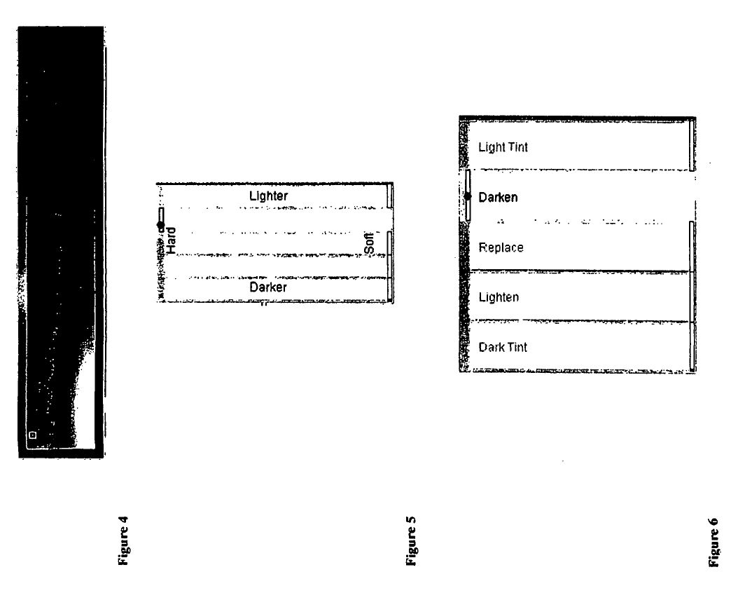

To reduce the number of mouse button clicks when selecting the values for a 3 valued variable, such as colour, a colour picker is used. In this case colour is represented by, for example, three values representing the ‘hue’, ‘saturation’ and ‘intensity’ (or greyscale value). This is just one of many colour spaces that are used to represent colour, others include RGB (red, blue, green) and CMYK. FIG. 4 shows a means for using a two dimensional panel to select three values from three separate ranges. It is often called a colour picker. Hue is selected by clicking somewhere on the rainbow coloured border. This step is similar to selecting a value using a slider but it acknowledges the circular nature of the hue function. Saturation and greyscale brightness are selected in the single operation of clicking somewhere in the centre box. The position along the horizontal axis determines the saturation thus unsaturated, colourless, values are to be found on the left and fully saturated bright colours on the right. The position along the vertical axis determines the greyscale brightness thus black is at the top and white at the bottom. The advantage of this colour picker is that a single mouse click allows two values to be chosen from separate ranges and this is easier and quicker than adjusting two sliders sequentially to select a particular pair of parameters.

In other words a colour picker is a type of parameter picker. A parameter picker can be described as a two dimensional selection panel with axis X, Y. The panel accepts mouse clicks and the parameters are set by the X, Y position on the panel that is selected or clicked. In the colour example let f_{c}(H,S,V) then the parameters of the function f_{c} are selected according to the values of Xᵢ, Yᵢ that have been selected on the panel: Hᵢ=H(Xᵢ,Yᵢ), Sᵢ=H(Xᵢ), Vᵢ=H(Yᵢ).

The complexity and speed of operating a graphical user interface is closely related to the number of keyboard and mouse actions that are required to produce a given effect: more actions reduces the speed and efficiency of operation. The invention improves user interfaces by reducing the number of actions required for a given effect by reducing the number of actions required to select a particular function.

According to the present invention there is provided a graphical user interface for enabling a user to input data to a software operating device, the interface comprising:

a display;

means for receiving selected position data representing a selected position on the display from a user; and

means for converting the selected position data to function identification information for the software operating device; wherein the display is arranged to display a selection panel representing a plurality of functions, the panel having an array of regions aligned in a first direction, each region representing a function, and wherein the positional data is converted to function identification information by considering the position within the panel in the first direction and also in a directional orthogonal thereto.

The software operating device may be configured to operate as a graphics package. The user may select the position on the panel by operating a mouse or touch pad and/or by touching the display.

Although keyboard and mouse input devices to computers are very common they are not the only alternatives. Touch screens are important particularly in publicly accessible ‘kiosks’. Pull down menus are difficult to operate using a touch screen and so it is desirable to find a compact alternative way to select different functions. The invention improves user interfaces by making multiple functions easily accessible from a graphical user interface.

An example of the present invention will now be described with reference to the accompanying drawings, in which:

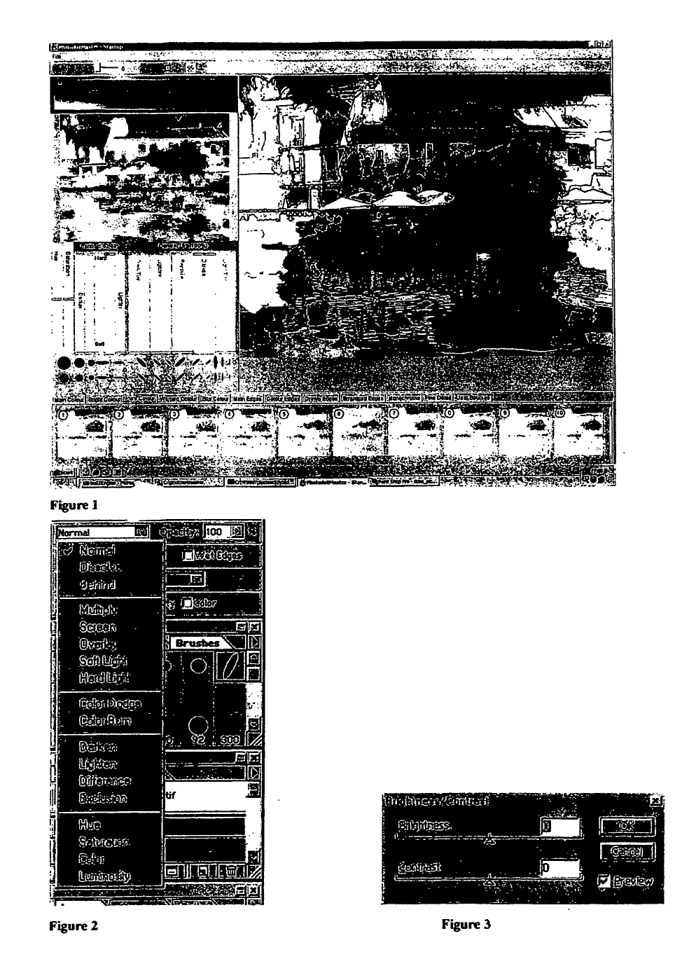

FIG. 1 is an example output of the interface of the present invention when used in combination with a graphics process;

FIG. 2 is an output from a traditional pull-down menu as known in the art;

FIG. 3 is an example of a known slider selector;

FIG. 4 is an example of a known “color picker”;

FIG. 5 is an example of the interface of the present invention configured to select contrast and brightness; and

FIG. 6 is an example of the interface of the present invention configured to be employed with a graphics package.

The interface of the invention which provides a function picker is now described. It is similar to a parameter picker of the type described above, but instead of simply selecting parameters of one function, the X, Y position determines not only the parameters but also the function to be used. The interface of the invention is arranged such that there is either a distinct transition point from one function to the next, or so that it is possible to blend the functions so that there is a smooth transition between functions. In other words, a function picker employed by the invention can be described as a two dimensional selection panel with axis X, Y. The panel accepts mouse clicks and/or touch selection and the function and its parameters is set by the X, Y position on the panel that is selected or clicked.

FIG. 6 shows an example. There are five different functions (DT, L, R, D, LT) that are different ways in which two images, A, B, or a brushed colour and an image may be combined, c.f. the pull down menu example shown in FIG. 2. In FIG. 6 a dark spot shows the point on the panel that has been selected (clicked) it corresponds to function D. Selecting the mid-point in the Light Tint column at the same Y would correspond to function LT. Selecting a point, k (k=0, . . . , 1), between the two will cause a blend of the two to be selected, k.D+(1−k)LT. Likewise for the other functions. Thus the choice of X determines the function to be selected. In this example the selected Y determines a parameter of the overall blending function namely the amount, K(K=0, . . . , 1), of the paint or second image B that is applied through k.D+(1−k)LT to the main image A. Overall, the output image is Kᵢ.(k.D+(1−k)LT)+(1−Kᵢ)A. where Kᵢ=K(Yᵢ).

It is the selected position on the two dimensional panel illustrated by the dark spot in FIG. 6 that determines the function and parameters of the system that blends two images. To make it easier for a viewer to understand the panel is visually (but not in practice) divided into five vertical strips, one representing each function. A virtual vertical slider indicates the amount of paint that is applied and a second small horizontal slider indicates the relative contributions of adjacent functions to the overall function. The two virtual sliders are controlled by a single mouse click onto the panel.

A similar interface system according to the invention can be used to specifically control the contrast and brightness of an image.

1. A graphical user interface for enabling a user to input data to a software operating device, the interface comprising:
a display;
means for receiving selected position data representing a selected position on the display from a user; and
means for converting the selected position data to function identification information for the software operating device; wherein the display is arranged to display a selection panel representing a plurality of functions, the panel having an array of regions aligned in a first direction, each region representing a function, and wherein the positional data is converted to function identification information by considering the position within the panel in the first direction and also in a directional orthogonal thereto.

2. The interface of claim 1, arranged to operate with a software operating device configured to operate as a graphics package.

3. The interface of claim 1, wherein the user may select the position on the panel by operating one of a mouse or touch pad.

4. The interface of claim 1, wherein the user selects the position on the panel by touching the display.
